(19) United States
(12) Patent Application Publication
(10) Pub. No.: US 2005/0171805 A1
(43) Pub. Date: Aug. 4, 2005

(54) Streamlined procurement system

(76) Inventors: Liam Casey, Donoughmore (IE); Dara Murphy, Blackrock (IE)

Correspondence Address: FENWICK & WEST LLP, SILICON VALLEY CENTER, 801 CALIFORNIA STREET, MOUNTAIN VIEW, CA, 94041, US

(21) Appl. No.: 11/021,458

(22) Filed: Dec. 22, 2004

Related U.S. Application Data
(60) Provisional application No. 60/532,481, filed on Dec. 24, 2003.

(51) Int. Cl. G06F 17/60

(52) U.S. Cl. 705/1

(57) ABSTRACT

A procurement management system automates aspects of procurement management and allows users to send and track procurement and good/service requests. The system receives procurement requests and automatically generates goods/services requests to be provided to suppliers in order to meet the needs of the procurement request. Once suppliers have provided replies to the requests, the system formulates bids or submissions to the procurement requests based on the replies.

### CROSS REFERENCE TO RELATED APPLICATIONS

This application claims the benefit of U.S. Provisional Application No. 60/532,481, filed Dec. 24, 2003, which is herein incorporated by reference in its entirety and is related to U.S. Utility patent application Ser. No. 10/846,497, filed May 14, 2004, which is herein incorporated by reference in its entirety.

### BACKGROUND

1. Field of the Invention

The present disclosure relates in general to product procurement and specifically, to methods and interfaces for streamlining procurement.

2. Background of the Invention

The production of goods often requires manufacturing inputs along the supply chain such as parts and services to be provided from a variety of different sources. For retailers, globalization of the parts market has translated into a wealth of choice among various suppliers, all vying to fill individual retailer procurement requests. Because the supplier market is highly volatile, with the entry and exit of various suppliers, finding a reliable supplier at a low cost requires specialized knowledge of the supplier market. To leverage this specialized knowledge, the process is often outsourced to third parties who manage production and may also provide inputs to the production process. Rather than issuing multiple requests for quotes (RFQs) or proposals, to cover each input, for instance, a retailer can instead issue a single RFQ, for the completed product.

Although resulting in a lower cost of production, the process of soliciting bids from and selecting suppliers for individual procurement requests is typically time-consuming and resource intensive. A third party procurement manager, for instance, must often respond to procurement requests by in turn issuing requests at the component level to component suppliers. Based on offers provided by the component suppliers, the procurement manager can then formulate a response to the retailer's procurement request.

There are currently few specialized tools available to help in this process. Bids, coming in from different suppliers in different forms, are often tracked manually. Terms negotiated in the back-and-forth between the procurement manager and supplier often need to be transcribed from one medium (for instance an email or phone conversation) to another. Routine calculations such as adding markups or freight costs must typically be performed manually by the manager. The inefficiencies are compounded when multiple procurement requests must be tracked, each with its own set of supplier requests and responses.

What is needed, therefore, is a way to automate the generation of procurement request responses based on supplier offers to provide components of the procurement requests.

### SUMMARY OF THE INVENTION

Embodiments of the present invention facilitate the management of procurement requests. It may be deployed in a variety of consumer industries, including, among others, electronics and computers, telecommunications, technology, automobile, commodity, and construction industries, and prove particularly useful in the context of Supply Chain Management (SCM), procurement management, Consumer Chain Management (CCM), Consumer Relation Management (CRM), and Enterprise Resources Planning (ERP).

In an embodiment, a procurement management system for preparing a submission in response to a procurement request is provided. The system includes a database containing a plurality of records corresponding to procurement request. Each record specifies a plurality of goods/services associated with a procurement request. A description of each of the plurality of goods/services is included in the database. A supply module can automatically retrieve goods/services descriptions from the database, formulate requests for the goods/services, and receive replies to the requests from a supplier. Based on these replies, a submissions module can automatically generate a submission responsive to the procurement request.

In another embodiment, a computer program product is provided for managing the supply of goods/services to fulfill a procurement request. The computer program product contains instructions for accessing a database of records corresponding to procurement requests. The database comprises information about each of a plurality of goods/services associated with a procurement request. In connection with a procurement request, a request can be formulated for goods/services associated with the procurement request. One or more requests may be transmitted to a supplier, and a reply may be received in response to each of the goods/services responsive to the requests.

### BRIEF DESCRIPTION OF THE DRAWINGS

FIG. 1 is a block diagram of a procurement management system in accordance with an embodiment of the invention.

FIG. 2 depicts a user interface for accessing records associated with procurement requests in various stages of the fulfillment process in accordance with an embodiment of the invention.

FIG. 3 depicts a user interface for searching for a procurement request in accordance with an embodiment of the invention.

FIGS. 4 and 5 depict user interfaces for adding and viewing a procurement request record to a database in accordance with an embodiment of the invention.

FIGS. 6, 7A-7B, and 8A-8D depicts user interfaces for adding parts and/or parts information to a procurement request record in accordance with an embodiment of the invention.

FIGS. 9 and 13A depict user interfaces for generating a parts request to be provided to a supplier based on a procurement request in accordance with an embodiment of the invention.

FIG. 10 depicts an email message soliciting a supplier quote generated in accordance with an embodiment of the invention.

FIGS. 11 and 12 depict interfaces for soliciting and receiving supplier quotes and re-quotes in accordance with an embodiment of the invention.

FIGS. 13B, 15, and 16 depict interfaces for generating a response to a procurement request based on supplier quotes in accordance with an embodiment of the invention.

FIG. 14 depicts an interface for selecting supplier quotes for a customer quote or submission in response to a procurement request in accordance with an embodiment of the invention.

FIG. 17 depicts an interface for managing the submission of samples to a customer in accordance with an embodiment of the invention.

FIGS. 18-19 depict report outputs generated by a reporting module in accordance with an embodiment of the invention.

### DETAILED DESCRIPTION OF THE DRAWINGS

Reference will now be made in detail to several embodiments of the present invention(s), examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Procurement Management System

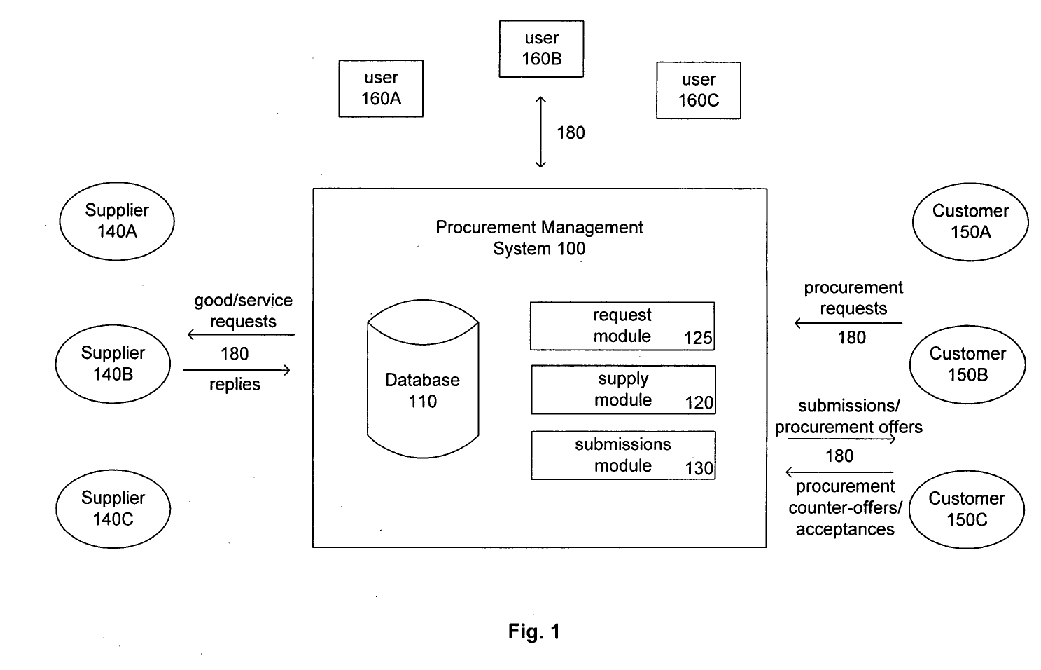

FIG. 1 is a block diagram of a procurement management system 100 in accordance with an embodiment of the invention. Customers 150 may issue procurement requests for various products, goods, or services. Using the procurement management system 100, users 160 can in turn request goods and services associated with the procurement requests from various suppliers 140. The procurement management system 100 accepts replies to the good/service requests and formulates user submissions to the procurement requests based on the supplier replies.

As used throughout this specification, the term “procurement request” refers to a communication supplied by an entity or individual that specifies a product, good, service or other item the entity or individual desires to procure, including a request for proposal, request for quotation, invitation or request to bid, or request for offer. The procurement request may comprise a solicitation that specifies a good, service, component, part, group of components, or group of products desired by the solicitor. It may include any of a variety of details including desired volume, rate of supply, price, price levels, preferred or approved vendors, shipping terms, customer location, specific part information, packaging, dimensions, environmental compliance information, comments, and/or preferences. Throughout the present disclosure, the term “supplier” includes a provider, sender, producer, or supplier of a good or service and the term “customer” is used interchangeably with the terms “receiver”, “buyer”, “assembler”, “retailer” and can refer to any of these or other requesting entities. In addition, the term “user” may refer to an in-house, independent, or third party procurement manager, a shipper, transit provider, middleman, assembler, broker, buyer and seller, or other party providing procurement services.

Procurement requests can be provided by customers 150 or users 160 to the procurement management system 100 for storage in records of the database 110 and can specify the goods/services to be used to fulfill the procurement requests. The terms “goods”, “services”, “goods/services”, and “good/service” may be used interchangeably and are intended to encompass finished or unfinished or raw goods, products, computer systems or sub-systems, assembled or unassembled production inputs, any of a variety of services, and groups of components, parts, goods, services, and/or goods/services, for sale to a distributor, consumer, assembler, or other supply chain party. For instance, embodiments of the present invention may be used to procure goods such as keypads, motors, or electronic, construction, or other subsystems which are to be integrated in products or systems before they are distributed for sale. Or systems disclosed may be used to procure finished goods to be sold to an end-user.

Based on a procurement request record, a user 160 can devise a set of good/service requests to source the items and/or services required to fulfill the procurement request using a supply module 120 of the procurement management system 100. As used herein, the term “module” can refer to computer program logic for providing the specified functionality. A module can be implemented in hardware, firmware, and/or software. The user 160 may access the procurement management system through a computer, laptop, handheld, cell phone, or other networked device. In an embodiment, interfaces generated by the procurement management system are accessed through HTML pages served over a network connection that can be accessed through the internet, an enterprise intranet, or another network and rendered by the user's browser.

The procurement management system 100 is comprised of a database 110, request module 125, supply module 120, and submissions module 130. The database 110 comprises a repository of data records that could take the form of any of a variety of conventional data structures including a relational database management system (“RDBMS”), lightweight data access protocol (“LDAP”) server, or flat files. The data may comprise procurement requests, good/service requests, replies from suppliers, procurement request submissions and/or procurement offers, counter-offers, contact and other information about suppliers 140, customers 150, and users 160, as well as instructions, messages, data, or notations from the parties.

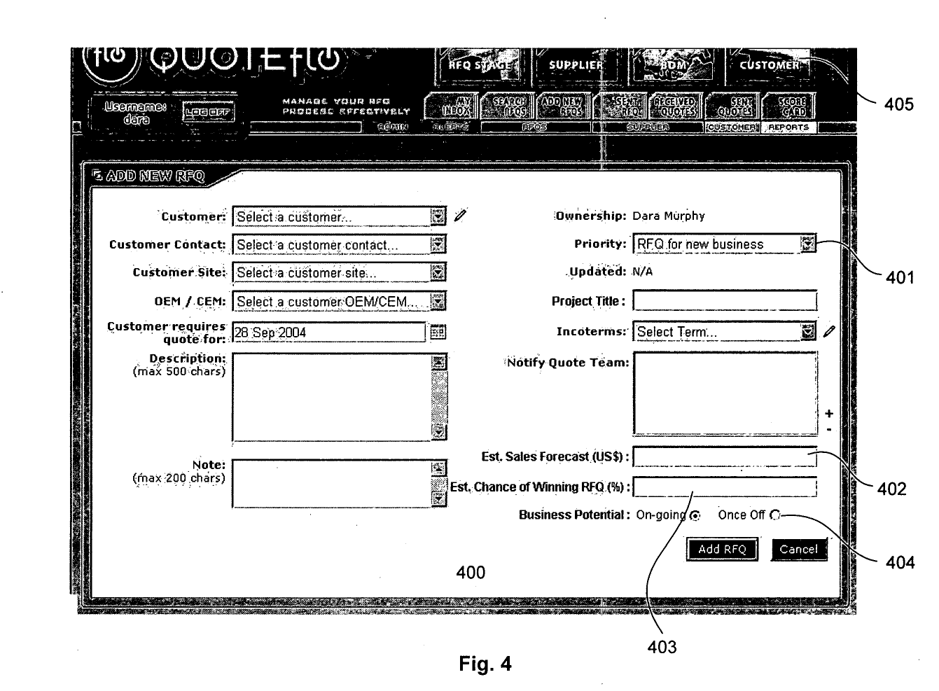

The request module 125 accepts procurement request information 180 from customers and stores the information to the database 110. A user 160, customer 150, or other party can add, edit or view a procurement request record to the database 110 using graphical user interfaces generated by the request module 125 such as those depicted in FIGS. 4, 5, and 6, 7A-7B, and 8A-8D. Procurement information from the customer can be supplemented by business forecasts and/or related marketing information provided by a user as well as comments from other parties who may be involved with the client, product, or relevant suppliers. A user or customer can also add specific parts information to the record. As discussed throughout this disclosure, these and other graphical user interfaces or visualizations may be implemented via a web browser in one embodiment. Other suitable graphical presentations may be adopted in alternative embodiments. Various graphical programming languages may be used as appreciated by a skilled computer engineer.

The supply module 120 accesses procurement request information stored in the database 110 and uses it to formulate and send good/service requests to various suppliers asking them to supply components, goods, materials, parts or services to service a procurement request. For example, to respond to an RFQ for a handheld gaming device, a user may solicit chip fabrication services from one set of suppliers, component parts from another, and assembly services from another. The supply module 120 can generate pre-populated templates for good/service requests to be sent to individual suppliers to be sent automatically or upon user approval.

In an embodiment, the supply module 120 transmits good/service requests to suppliers 140, and receives and track responses to the requests. The requests may be transmitted using phone, email, mail, instant message or other existing or emerging communication means to a supplier address stored in the database 110. If the supplier provides no response within a given period of time, the supply module 120 may automatically sent a re-request to the supplier. Similarly, the supply module 120 may take an action upon receiving a response. In addition to updating the status of the good/service request, the supply module 120 can compare a response to the original request. If the differences, for instance in terms of price or other financial term, volume, schedule or other metric are calculated to be within a certain threshold, the supply module 120 may send a preliminary acceptance to the supplier. If the quote is too far out of line with the request, on the other hand, a user 160 may use the supply module 120 to request a re-quote or provide a compromise request.

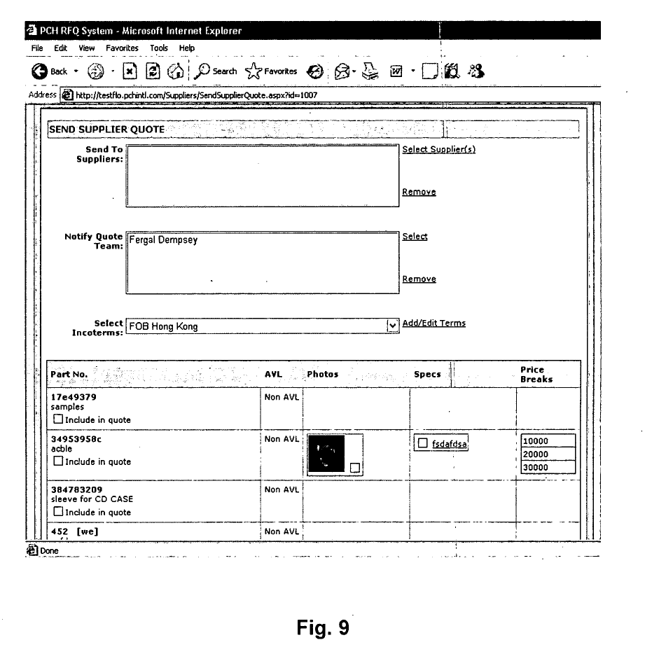

Status information regarding each procurement request and good/service requests is stored to the database 110 to be reviewed by the user 160. Using interfaces such as those shown in FIGS. 9-12, described in greater detail below and generated by the supply module 120, a user 160 can avoid the need to manually keep track of procurement requests received and associated good/service requests sent in association with the requests.

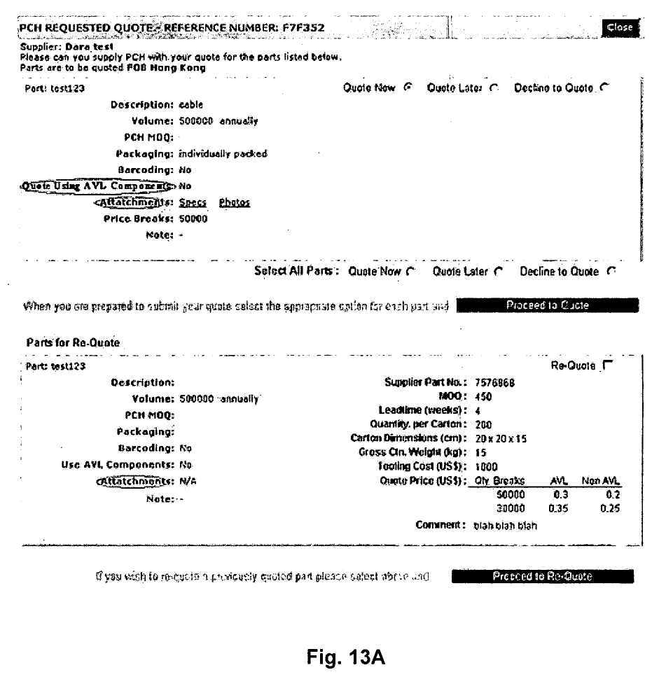

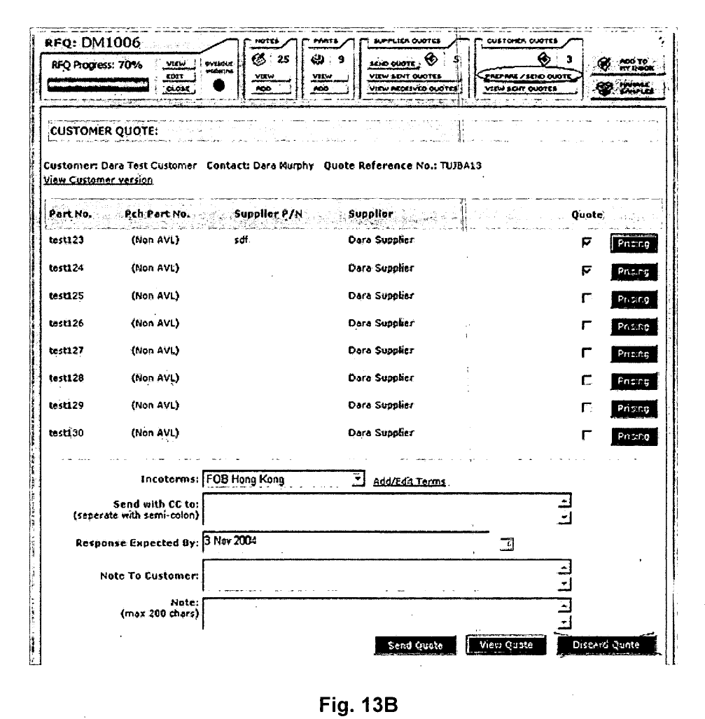

A user 160 can use the submissions module 130 to develop a submission or procurement offer in response to the request. The submissions module 130 uses the good/service request replies received from various suppliers to formulate this request. Using interfaces such as those represented by FIGS. 13-16, a user 160 may select certain suppliers or supplier quotes/replies, add markup, shipping, handling, or other costs, and devise a completed submission or procurement offer in response to a procurement request. A user 160 may provide specific instructions to a submissions module 130 regarding how to prepare a particular submission, or may provide instructions to be used generally with all or certain subsets of submissions, to specify for instance that a certain markup be added to all estimates during peak procurement season. Once the user 160 has approved a submission, the submissions module 130 transmits it to the customer 150 associated with the submission. Ensuing counter-offers and negotiations can be provided through the procurement management system 100 to a user 160 or customer 150. This way, the submissions module 130 can track the status of the procurement request submission to its final resolution.

The data and communications 180 exchanged between various users 160, customers 150, and suppliers 140 and the procurement management system 100 may take place over any combination of networks and network connections. As discussed throughout this application, the terms “network” and “network connection” may refer to any connection or combination of connections supported by a digital, analog, satellite, wireless, firewire (IEEE 1394), 802.11, RF, local and/or wide area network, Ethernet, 9-pin connector, parallel port, USB, serial, or small computer system interface (SCSI), TCP/IP, HTTP, email, web server, or other communications device, router, or protocol. In some cases, a network connection may be provided by a conventional phone line, for instance, used by a supplier 140 to call in the status of a certain part. Phone automation technologies such as voice recognition or touch-tone detection may be used.

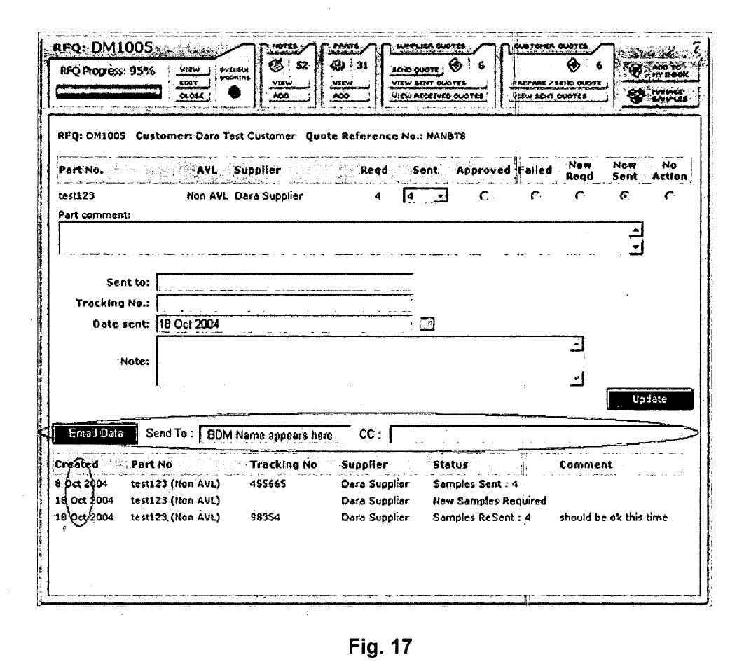

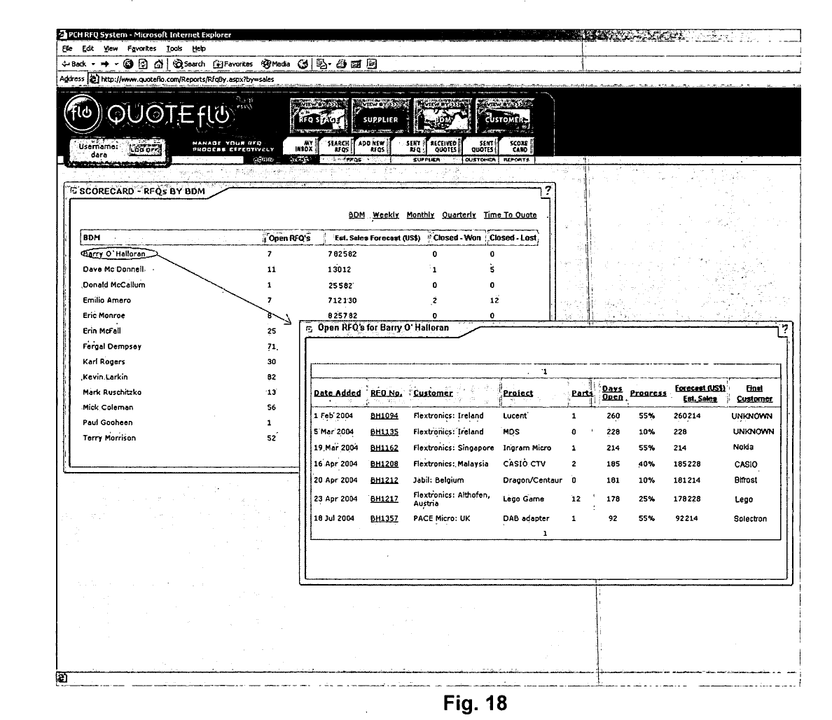

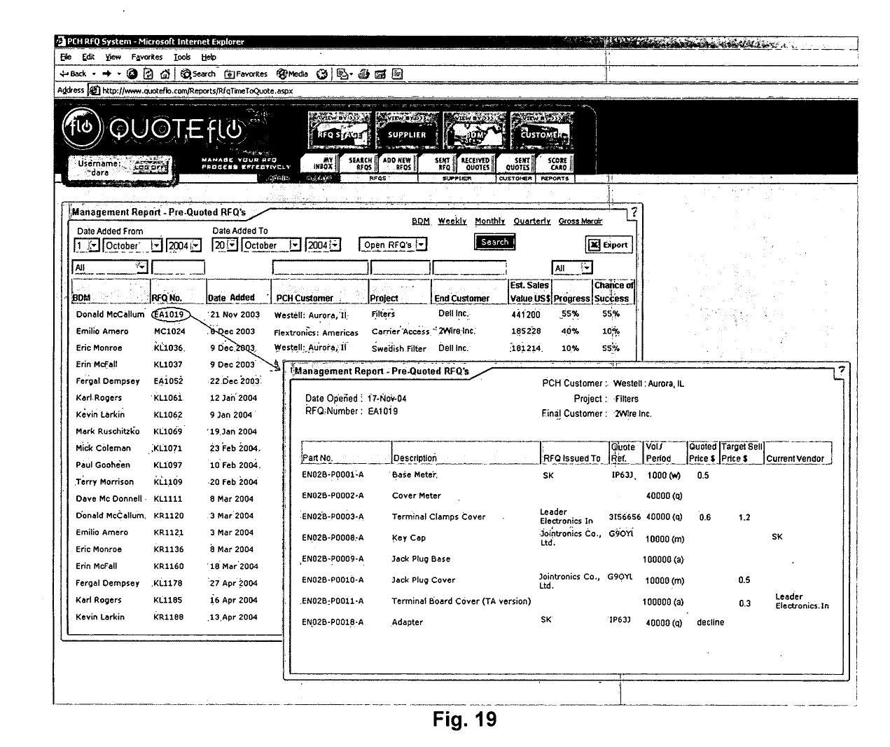

The procurement management system 100 of FIG. 1 is comprised of a database 110, request module 125, supply module 120, and submissions module 130. However, it is not necessary for every embodiment of the invention to include all of the elements depicted. In addition, other modules, such as a reporting module for generating reports such as shown in FIGS. 18-19 or a sample module for enabling the management of samples through interfaces such as shown in FIG. 17 and described in further detail below, may be added. It is not necessary for the elements to be housed as shown, for instance, the database 110 or other system elements could be hosted on disparate servers and content served upon request. Furthermore, the users 160, suppliers 140, and customers 150 may belong to any combination of the same or different entities or enterprises. In an embodiment, for example, manufacturing parts or product components may be provided by various in-house and external supplier organizations of a single corporate entity or enterprise, or individual suppliers can be independent parties.

Accessing Procurement Data

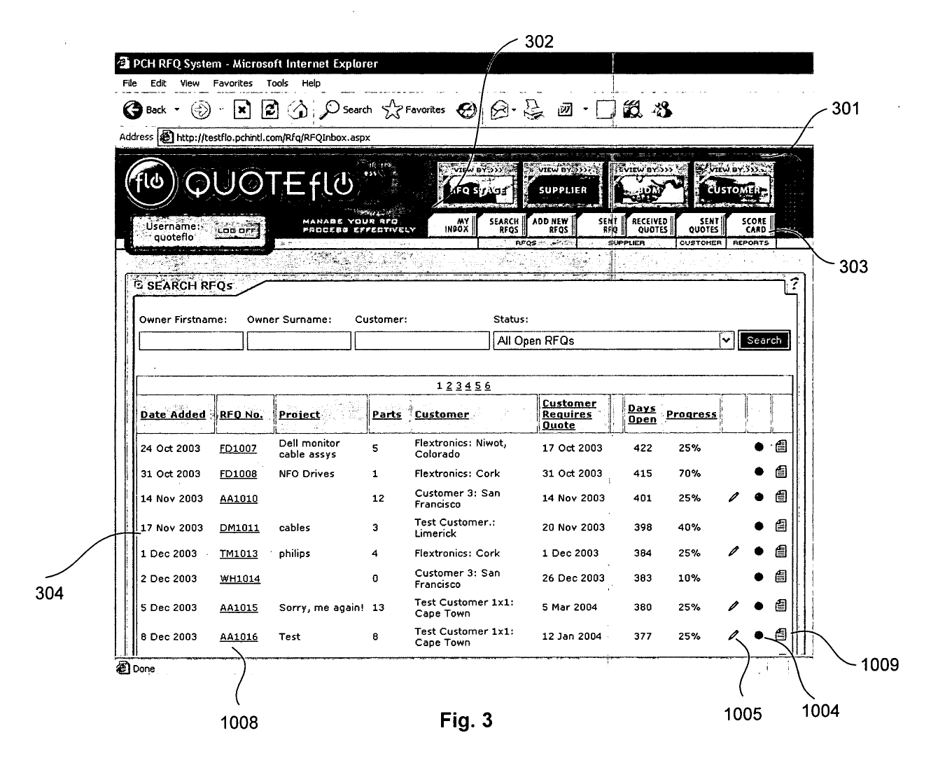

Procurement information, data, and communications can be accessed through the procurement management system 100. In an embodiment, a user 160 can log on to a website or other display or interface using an authorized password and user name that can be accessed only by a registered user. Information specific to the user 160, which may be stored in a database 110, is called and provided to the user 160 at various points as the user 160 navigates through a series of interfaces. FIG. 3 depicts a user interface for searching for a procurement request in accordance with an embodiment of the invention. Several tools for accessing procurement requests at different stages of completion are offered. For example, a horizontal menu 301 is provided that corresponds to the ordered sequence of events or parties involved in a procurement transaction. The visual images of the menu 301 likewise correspond to the events or parties involved in a transaction. For instance the “supplier” item of the menu 301 is portrayed by the word “supplier” set against a picture of a factory and smokestack. As shown on the menu 301, a user's records may be viewed by each of these stages. A second horizontal menu 302 is organized to correspond to various stages or actions in a sequence in which they would naturally occur. The party or item that each of the actions is associated with is further listed below in a third horizontal toolbar 303. The horizontal menu bars 301 and 302 remain available as the user 160 navigates various interfaces so that the user 160 can access the content without having to return to a central “home page.” This reduces the number of clicks needed for a user 160 to access relevant content.

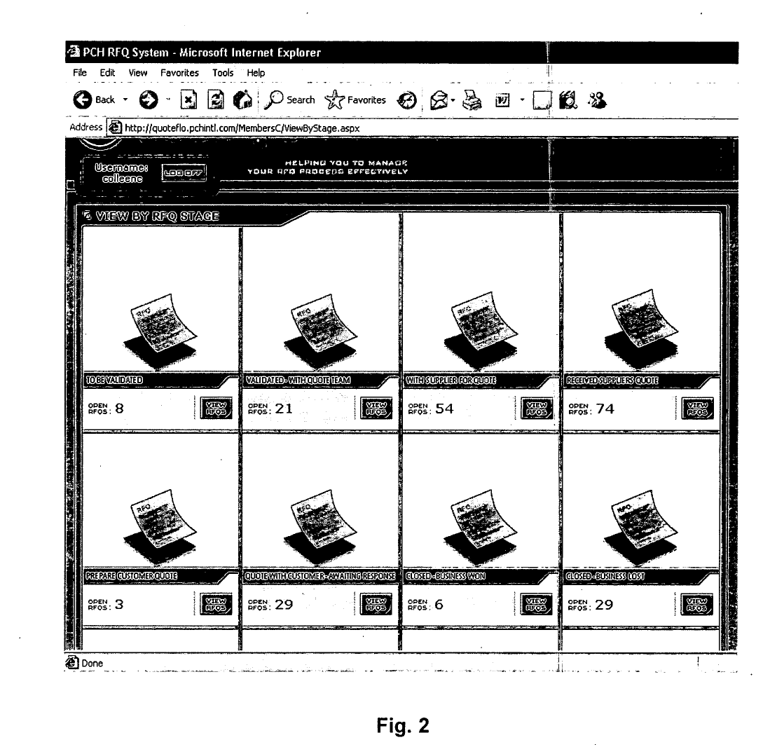

Clicking on each item of any of the menus brings the user 160 to various parts of the website corresponding to the item. For instance, a user 160 who clicks on “View by RFQ Stage” in the first menu 301 might see a view as depicted in FIG. 2. Each of several possible “RFQ” stages—“to be validated,” “validated—with quote team,” and “with supplier for quote,” for example—is depicted graphically as shown. Other stages may be established as needed. The stages are ordered in accordance with how they would naturally occur during the procurement process, allowing the user 160 to quickly obtain a global view of all open RFQs. As actions on individual RFQs are taken within or outside of the procurement management system 100, they may be moved from one status to another. For instance, once the supply module 120 sends a message to a supplier, the supply module 120 updates the status of the procurement request to “with supplier for quote.” Or, a user 160 can manually change the status of a RFQ.

The interface contains features that allow a user 160 to more easily assess how to allocate resources and effort. The number of RFQs in each stage is represented in two ways—through a number displayed prominently, e.g. “8” in the case of RFQs in the “to be validated” stage, and through the size of the stack of papers in the image corresponding to each stage. For instance, the stack of papers shown in the image associated with the RFQs “received suppliers' quote” (74) appears proportionally larger than stacks of papers associated with other stages with fewer open RFQs.

The user interface of FIG. 3 can be used to search for various RFQs by any of a number of different fields, including user or owner, customer, and status. The status menu shown is a pull down menu that allows a user 160 to quickly view requests that need to be validated, for example. Sub-menus and other graphical components may also be adopted. The lower portion 304 of the interface lists RFQs sortable on the basis of any of a number of fields such as date added, RFQ No, and Project. A user 160 may sort the table 304 by each column header by clicking on the column.

The table conveys information about the RFQ in an intuitive manner. The table includes a flashing “overdue warning” indicator 1004 that appears in the table entry whenever the date for an RFQ has passed. This interface alerts the user to attend to high priority RFQs. In addition, based upon information about the user, a pencil indicator 1005 is provided to indicate that an RFQ has been updated by another user 160. The pencil indicator 1005 allows users 160 to synchronize their access to a given RFQ. To select and view an RFQ, a user 160 may click on a link to a RFQ number 1008, or a graphical image of a piece of paper in a row of a table that corresponds to a particular RFQ 1009.

Adding Procurement Requests

FIG. 4 shows an interface for adding a new RFQ record to the database 110 using an on-line form that includes pre-populated pull-down menus for filling out fields in the form such as customer, customer contact, and customer quote. In an embodiment, quote or request information provided to the request module 125 is saved both to the procurement request record being added and is also stored for future users 160 or customers 140 to access. A customer 150 and/or user 160 may add procurement information. In an embodiment, a customer 150 can enter portions of the RFQ such as description and part information, and a user 160 may then edit or comment on the RFQ. The user can, for instance, use a priority menu 401 to indicate if the RFQ is for a new business or other indicator, for instance. Or, one or more users 160, can use input fields 402-404 to provide an estimated sales forecast of how much revenue the project may bring in, provide an estimated chance of winning based on the user's knowledge of the market, or to indicate from a business perspective whether the client has the potential to become an on-going client. Other metrics, either provided by a user 160 or calculated by the request module 125, could also be used. For instance, the request module 125 could determine, based on previous records, what the historical win rate is for a certain customer 150. The information provided could be useful for determining how to best go about pursuing the RFQ for instance what if any discount may be given to the customer 150 or any special efforts that may be effective in winning the RFQ.

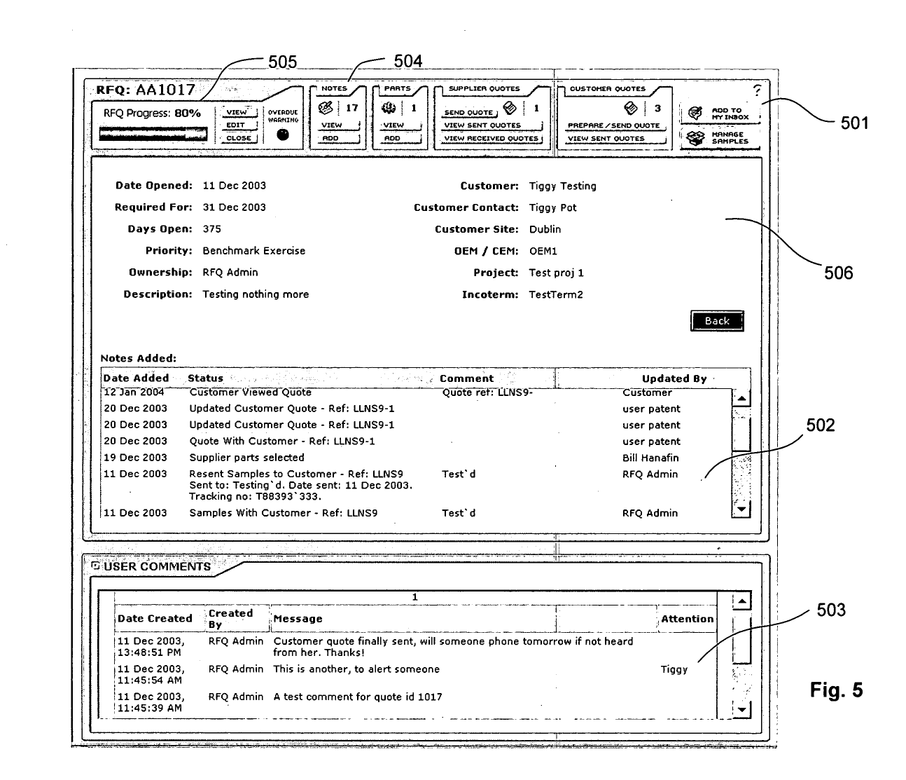

Once the main terms of the RFQ have been added, the RFQ or quote request can be viewed through an interface such as the one shown in FIG. 5. As shown, the interface 500 includes an RFQ toolbar 501 with options for notating, editing, or taking actions based on the RFQ. Using the notes section of the toolbar 504, for instance a user can quickly see that seventeen notes are present in the record, or be brought to an interface for viewing or adding a note with one click. Similarly, the parts, supplier, and customer quote portions of the toolbar convey the number of items under each category and allow the user to take appropriate actions.

Other information is conveyed in the RFQ Progress 505 portion of the toolbar 501, for instance how far along the RFQ is (80%), and whether a response to the customer is overdue. Other warnings or messages, conveyed in different ways, could also be implemented. Each category of actions is depicted in an intuitive manner—for instance an image of a cog corresponds to the “parts” category, and an image of a piece of paper and pencil to the “notes” category. Within different parts of the toolbar 501, action buttons, for example a “close” button, are presented in an intuitive way to allow the user to take various actions in connection with the RFQ.

The RFQ viewing interface 500 includes a top portion 506 that shows the basic information about the RFQ. It also includes a middle portion 502 where a scrollable display of notes is located, and a set of user comments in a lower portion 503. Notes or comments added through the notes interface accessible from the notes toolbar 504, for instance, can be recorded in one of these sections. Notes may also be automatically added or generated by the procurement management system 100 whenever an action is taken—for instance a customer quote is updated, or samples are provided to a customer.

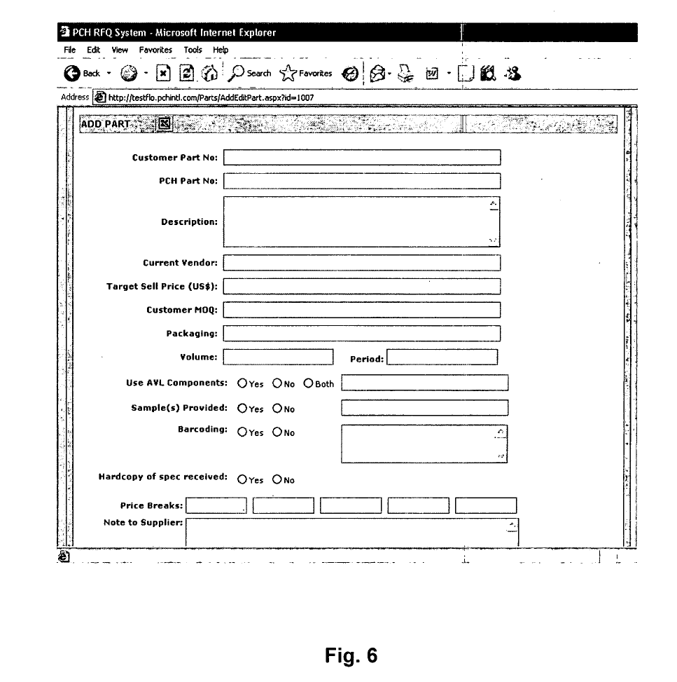

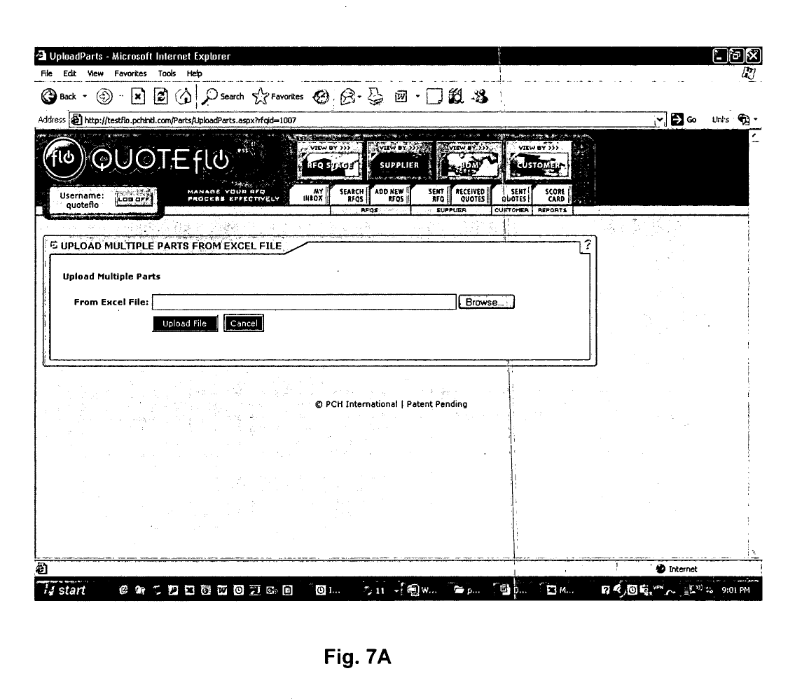

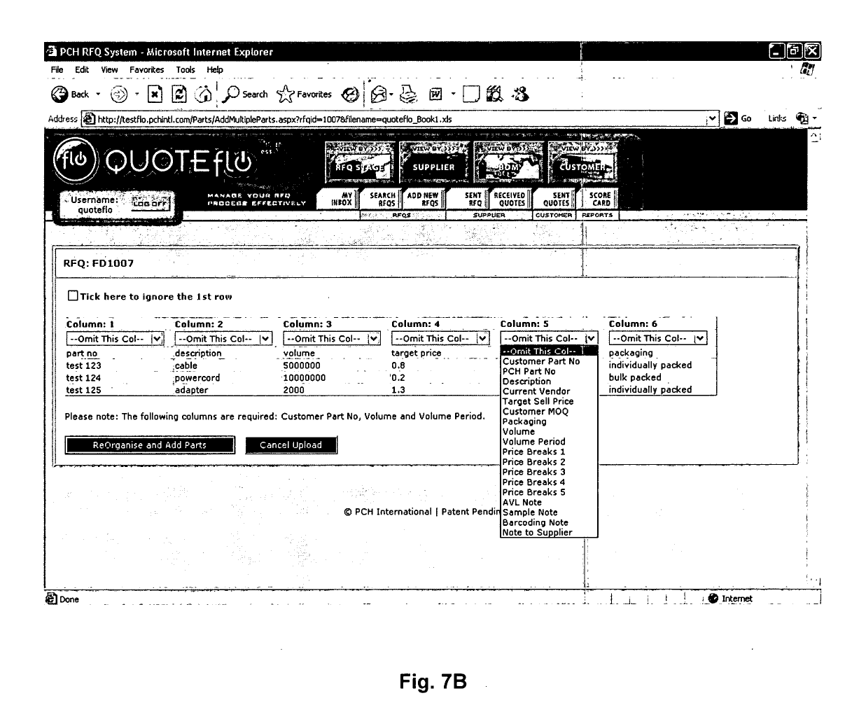

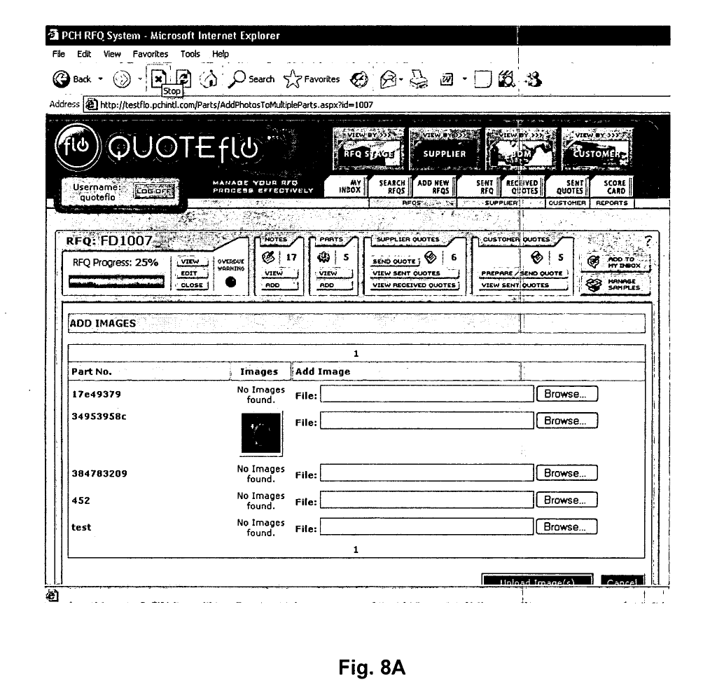

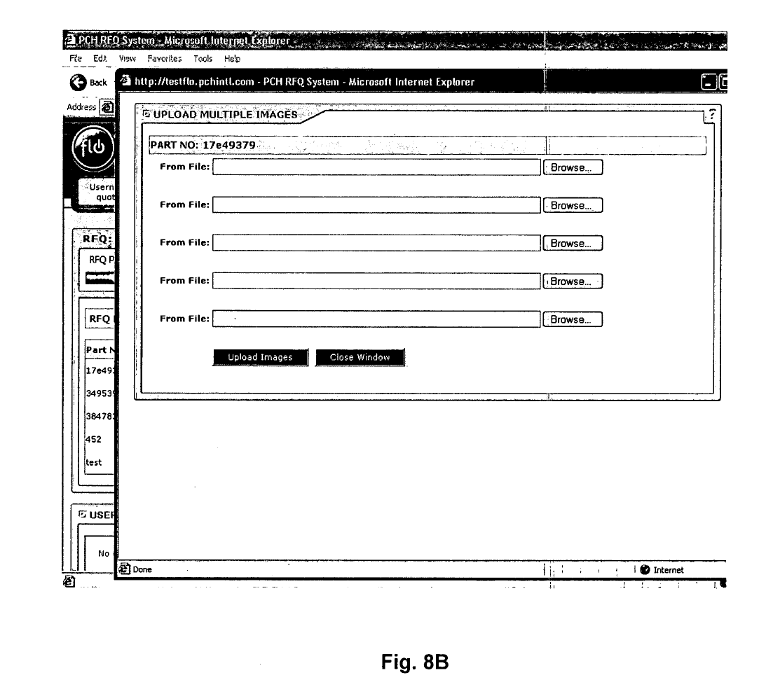

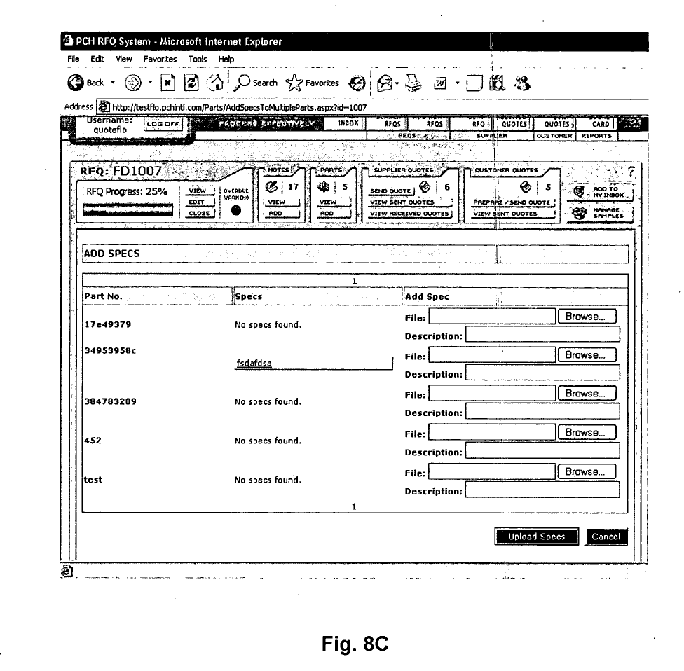

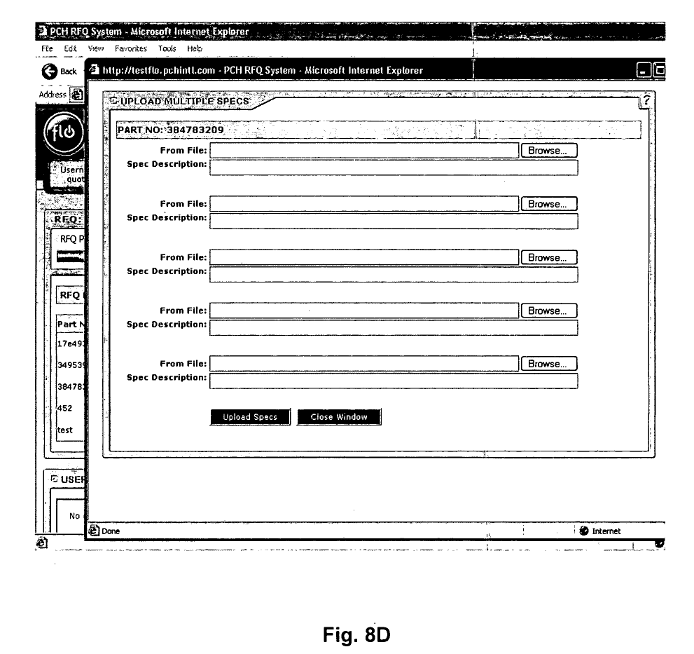

One or more parties can add goods, services, parts or component, or other information to an RFQ by to be stored in a procurement request record. In the case of an RFQ for a cell phone handset, information regarding the parts such as the cell phone chassis, display screen, antenna, power supply, and other components, for instance, may be provided. FIGS. 6, 7A-7B, and 8A-8D depicts user interfaces for adding parts and/or parts information to a procurement request record in accordance with an embodiment of the invention. Using the interface of FIG. 6, for instance, a user 160 can specify a customer part number and an equivalent system number, the vendor currently supplying the good, a target sell price, and other details about the part. A customer 140 or user 160 may also indicate whether the procurement request is to be filled using only vendors who are on the approved vendor list (AVL). Price breaks, requested for instance by a customer 140, can also be specified to take place at different order volume levels. Or, rather than filling in the fields of the interface of FIG. 6, descriptions of multiple parts can be provided simultaneously through interfaces such as that shown in FIG. 7A-7B. An excel file or other spreadsheet containing part information can be uploaded to the request module 125 using the interface of FIG. 7A. Using the interface shown in FIG. 7B, columns in the file can be matched to the various fields of the RFQ as shown in the menu under column 5. FIGS. 8A-8D show interfaces for adding multiple images or specification files using a single interface screen in connection with particular parts.

Goods/Services Procurement

After a procurement request has been added, a user 160 can use the supply module 120 to generate requests for individual goods/services required to fulfill the procurement request. FIG. 9 depicts a user interface for generating a parts request to be provided to a supplier based on a procurement request in accordance with an embodiment of the invention. The interface may feature pull down or other menus for choosing suppliers and other parties that should be sent the request based on data stored in the database 110. The interface is automatically populated with part information associated with a request for procurement. In another embodiment, a user 160 can specify that a template be populated with different groups of goods/services—for instance a user 160 could specify that all open requests for cords be provided to a cord supplier. In an embodiment, various portions of procurement requests can be aggregated and presented to suppliers, for instance comprising a request for a set of items to supply two different procurement requests, in order to capture volume discounts.

A user may select various details about the parts included in a request. It can specify a volume and price target for instance, as well as incoming terms (such as freight on board or other terms) from a list as well as add or edit terms from the list. In other embodiments, an interactive calendar is provided to allow the user 160 to choose an expected return date, and the user 160 is provided with options for including other part or note information to the supplier or in the record. Other fields may be provided according to user need. Once a user 160 enters all the information it wishes to send to a supplier, it can preview the quote as it would appear to the supplier and make changes, using an interface.

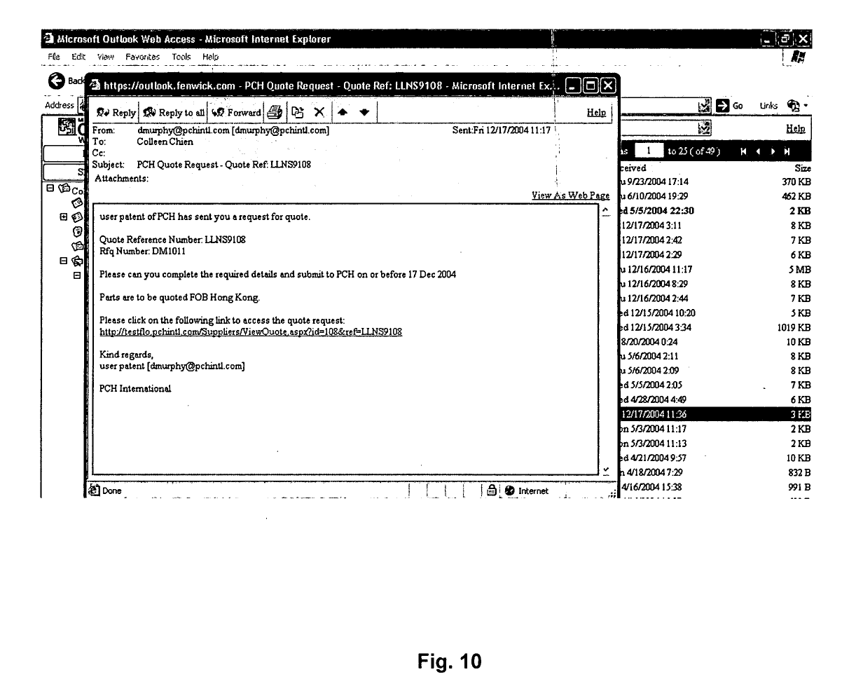

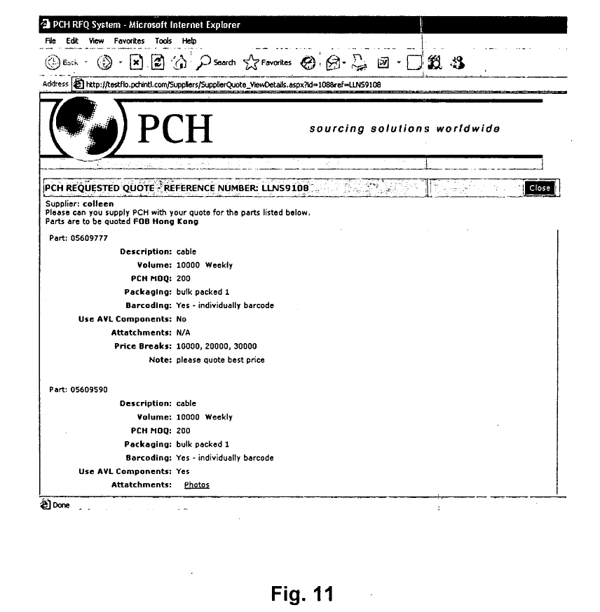

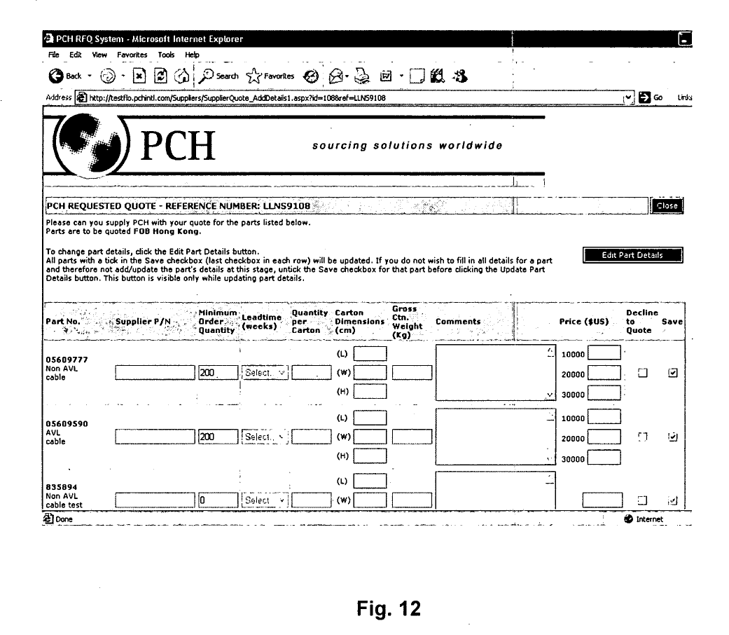

Once the user 160 has completed its parts request, the request may be sent by the supply module 120 electronically, through a fax, or other communication means. An exemplary email sent to a supplier 140 is provided in FIG. 10. It includes a link embedded into a text description to a secure website associated with the procurement management system 100. The link includes the necessary information (e.g., a client ID) to query the database 110 for the relevant parts request and supplier information, which is provided to generate an appropriate view for the user 160. When the supplier 140 activates the link in the email, a browser application is invoked and contacts the web server, passing in the parameters that identify the supplier 140 (e.g., the client ID). The web server creates a web page including form fields for each of the supplier request fields, and provides it to the browser. Exemplary web pages provided in this manner are shown in FIGS. 11-12 and 13A. As shown in FIG. 12, the supply module 120 generates an interface for receiving supplier quotes. The interface is pre-populated with parts information from the parts request, and provides a number of fields for the supplier 140 to specify a supplier number, lead-time, and other information about the terms on which the supplier 140 may supply the requested part. The interface of FIG. 13A allows a supplier 140 to quote now, quote later, or decline to quote, and also allows the supplier 140 to provide a re-quote to a user 160, as discussed above.

Alternatively, the supply module 120 can create and send a data object to a supplier 140 that provides fields in which the supplier 140 can enter data. The object could be a HTML (or XML or other) file that can be saved once new data is entered. This way, a supplier 140 does not have to be connected to a network to modify and save her data. The data object can also be a simple text file, a spreadsheet, a self-extracting, self-installing, executable application, or a Java applet.

Creating and Managing Submissions

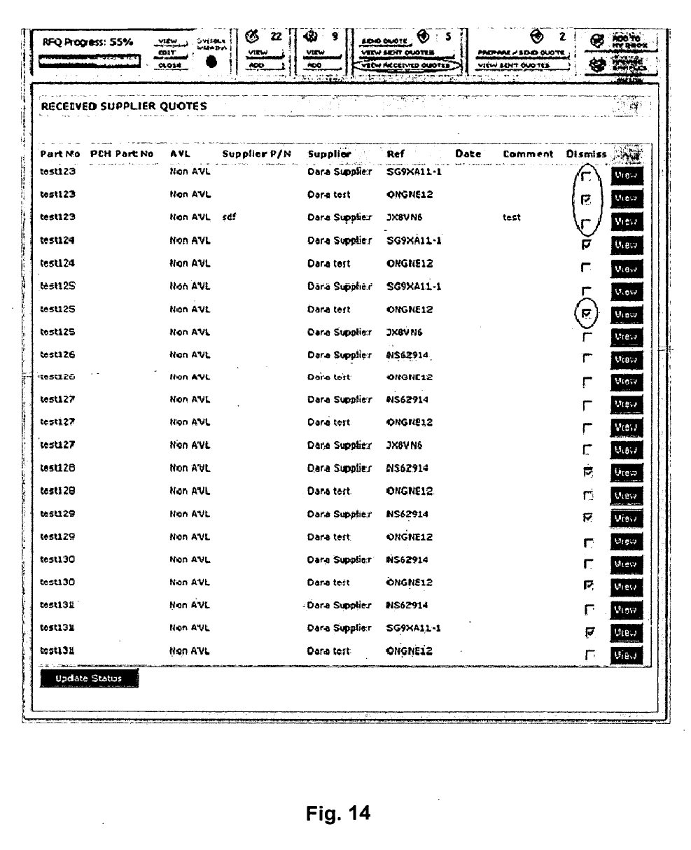

Once a user has received one or more supplier quotes in relation to a procurement request, it can use the submissions module 130 to devise a submission to provide to a customer based on the supplier quotes. FIG. 14 depicts an interface that lists all supplier quotes or replies received in connection with a procurement request. The interface shows the quotes in cursory fashion and allows a user 160 to select among various supplier quotes. Using a checkbox, a user 160 can indicate which quotes to dismiss, and these quotes will be not used to generate the submission. FIGS. 13B, 15 and 16 depict interfaces for creating a submission to a procurement request based on supplier quotes in accordance with an embodiment of the invention. Using the interface of FIG. 13B a user can specify the incoming terms, sending preferences, response date, and notes to the customer or record. The interfaces are pre-populated with information about the existing supplier part offers—identified by part and supplier—available to service the procurement request.

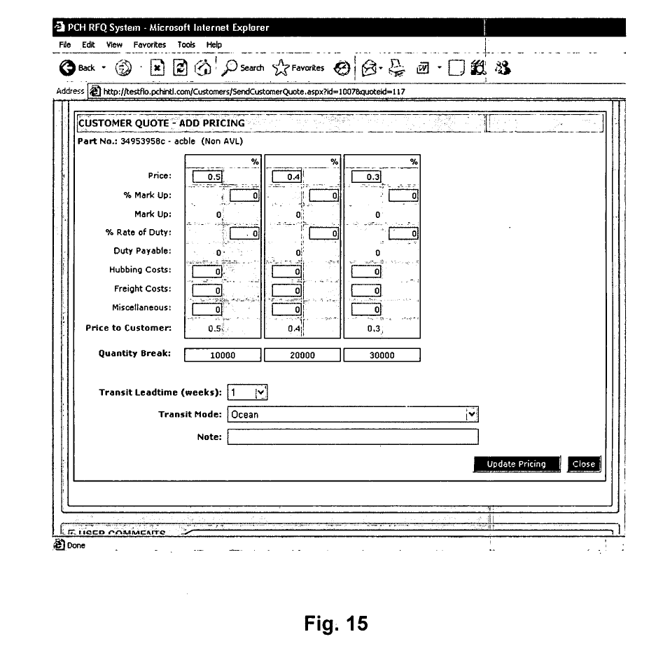

After choosing a supplier reply to include in a submission, the user 160 can add pricing information to the submission using the interface shown in FIG. 15. As shown, the interface is populated with price information at different quantities from the database 110 as provided by the supplier 140, and contains numerous fields through which the user can provide inputs or instructions to final price provided to the customer. For example, the user can specify that a certain markup % or amount be added to the price of a component, or that a taxation rate be applied, or that expenses for hubbing, freight, and other transport and miscellaneous be added. In an embodiment, assembly and finishing services are provided by a business unit or organization within the same enterprise as the user 160. In such a case, a user 160 can “charge” for the services through any of the fields shown in FIG. 15.

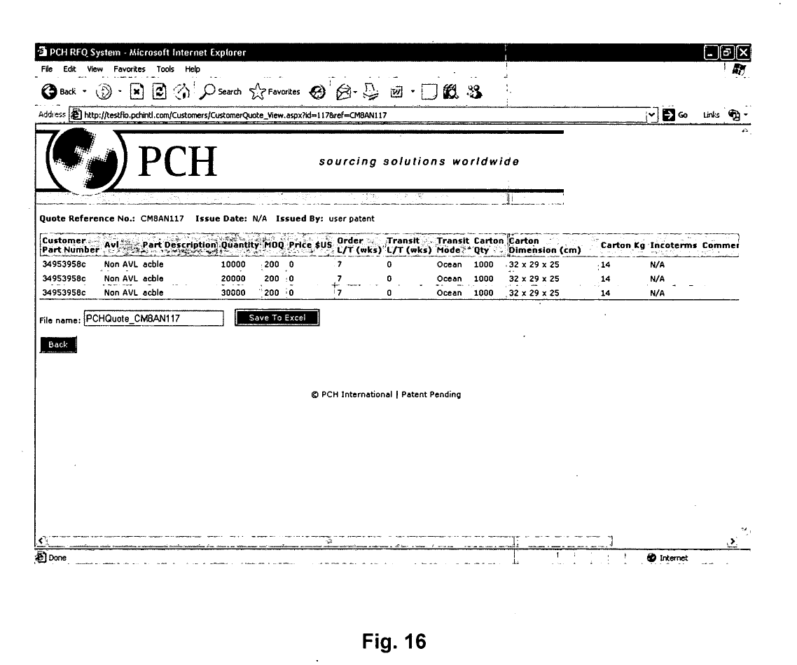

The entire submission can be provided through the submissions module 130 to a customer 140, who may see a view such as that shown in FIG. 16. This interface reports assorted part information and indicates details about the mode of transit, shipping preferences, and other details provided by the user 160 during the submission generation process or determined based on data stored in the database 110. Other types of pricing and information display can be used—for instance a total price of the complete product may be provided, or a graphical display that shows the projected revenue or cash flow associated with the payments going to the supplier and received from the customer, for instance. Where samples are required to be provided to a customer with a submission, a samples module can be used to manage the sample submission and approval process. A samples module may generate an interface such as shown in FIG. 17 to allow a user 160 to track, for instance, how many samples are required, how many have been sent, and what the status of a sent sample is, including approved, failed, new sample required, and new sample sent.

After the submission has been provided to the customer 140, the customer can reply to the submission directly through the submissions module 130. In an embodiment, for example, a customer 140 can view all open submissions and provide her comments or feedback on any element of the submissions using a user interface. Through this tracking functionality, the submissions module 130 can be used to track the status of the submission to completion.

Reports on the performance of a user 160, supplier 140, or customer 150 over the course of multiple procurement requests can be created by a reporting module of the procurement tracking system 100. FIGS. 18-19 depict such report outputs in accordance with an embodiment of the invention. FIG. 18, for example, shows a report through which the performance of various business development managers (BDMs) can be tracked. The open RFQ's, sales forecasts, and win-loss statistics are provided for each BDM. Clicking on an individual manager's name yields a more detailed list of the open RFQ's for the manager, as an example, a report for BDM Barry O'Halloran is shown. Offering another view, the interface of FIG. 19 shows all RFQs added during a certain period that have not yet been fulfilled. Key metrics such as estimated sales value and progress are provided. Each RFQ can be selected to generate a more detailed view of the parts or goods/services that comprise the procurement request, so that a user 160 can quickly assess how much work will be required to complete the submission. These dashboard performance views can help a user 160 to determine where efforts should be focused and benchmark sales teams members against each other. The reports can be downloaded to a spreadsheet or provided in a format conducive to further analyses and recommendations.

1. A procurement management system for preparing a submission in response to a procurement request from a customer, the system comprising:
a database containing a plurality of records corresponding to procurement requests, wherein each record specifies a plurality of goods/services associated with a procurement request and the database includes a description of each of the plurality of goods/services;
a supply module configured to automatically retrieve descriptions of a plurality of goods/services associated with a procurement request from the database, formulate a request for each of the plurality of goods/services to be provided to at least one supplier, and receive a reply to each of the good/service requests from the at least one supplier; and
a submissions module for automatically generating a submission responsive to the procurement request based on the replies to be provided to the customer.

2. The system of claim 1, further comprising a request module for receiving procurement request data for storage in a database record associated with the procurement request.

3. The system of claim 2, wherein the request module is configured to receive comments about a procurement request from a plurality of sources and store the comments in the database record.

4. The system of claim 1, wherein the supply module is configured to generate and send an email to a supplier including a request for a good/service.

5. The system of claim 1, wherein the supply module is configured to automatically send a second request to a supplier that has already been provided a first request for a good/service.

6. The system of claim 1, wherein the database comprises status information about procurement requests associated with records in the database.

7. The system of claim 6, wherein the status information is automatically updated in the database when an action of receiving a procurement request, sending a request for a good/service to a supplier, or generating a submission responsive to a procurement request is carried out.

8. The system of claim 6, further comprising a reporting module for generating a report based on the status of a plurality of procurement requests responsive to a user input.

9. A computer program product, the computer program product comprising a computer readable medium and computer program instructions encoded on the medium for:
accessing a database of records corresponding to procurement requests, each record specifying, in association with a procurement request, a plurality of goods/services and requested procurement terms, wherein the database comprises information about each of the plurality of goods/services and a plurality of suppliers; and
in connection with a procurement request:
formulating a request for each of the plurality of goods/services associated with the procurement request;
transmitting the request for each of the plurality of goods/services to a supplier of the plurality of suppliers; and
receiving a reply from a supplier for each of the plurality of goods/services responsive to a transmitted request.

10. The computer product of claim 9, further comprising instructions for, in connection with the procurement request:
generating a link to a secure web server, the link including information for identifying a supplier with which the secure web server can create a web page for soliciting a reply from the supplier to the request for the good/service; and
providing the link to the supplier.

11. The computer product of claim 9, further comprising instructions for automatically sending a second request to a supplier that has already been provided a first request for a good/service responsive to one of: non-response from the supplier to the first request within a designated time period, and the difference between a reply to the first request from the supplier and the first request exceeding a certain threshold.

12. The computer product of claim 11, wherein the difference between the reply and the first request is measured by one of a financial, volume, or scheduling term.

13. The computer product of claim 11, wherein the second request comprises a modified version of the first request and is responsive to the reply from the supplier.

14. The computer product of claim 9, further comprising instructions for, in connection with the procurement request:
generating a submission for the procurement request based on replies received from suppliers to provide the goods/services associated with the procurement request, wherein the submission price is based on the sum of prices associated with the replies received from the suppliers;
providing the submission to a user through a graphical user interface;
receiving an instruction from the user responsive to the submission; and
implementing the user instruction.

15. A computer program product for preparing a submission for a procurement request of a customer, the computer program product comprising a computer readable medium and computer program instructions encoded on the medium for:
accessing a database of records corresponding to procurement requests, each record specifying a plurality of goods/services associated with a procurement request and a supplier offer to provide each of the plurality of goods/services at a price; and
in connection with a procurement request of a customer:
generating a submission for the procurement request responsive to supplier offers to provide the plurality of goods/services associated with the procurement request, wherein the submission comprises a price based on the prices of the supplier offers;
providing the submission to a user through a graphical user interface;
receiving an instruction from the user responsive to the submission; and
implementing the user instruction.

16. The computer program product of claim 15, wherein a database record associated with the procurement request of the customer specifies a plurality of supplier offers to provide a good/service and further comprising code for, in connection with the procurement request of the customer:
receiving from a user a supplier offer selected from the plurality of supplier offers to provide the good/service; and
generating the submission responsive to the selected supplier offer.

17. The computer program product of claim 16, further comprising code for:
receiving a selection of supplier offers chosen from the plurality of supplier offers to provide the good/service; and
generating the submission responsive to the selection.

18. The computer program product of claim 16, further comprising code for, in association with the procurement request for the customer, electronically providing the submission to the customer.

19. The computer program product of claim 16, wherein the user instruction specifies that a markup and the prices of the supplier offers be used to calculate a submission price.

20. The computer program product of claim 16, wherein the user instruction specifies that one of a tax, transportation, and shipping cost be used to calculate a submission price.
